(19) United States
(12) Patent Application Publication
(10) Pub. No.: US 2008/0177848 A1
(43) Pub. Date: Jul. 24, 2008

(54) System and method of sharing and dissemination of electronic information

(76) Inventor: Anurag Wakhlu, Chelmsford, MA (US)

Correspondence Address: Attorney Indu M. Anand, 15 Green Way, Chelmsford, MA, 01824, US

(21) Appl. No.: 12/006,012

(22) Filed: Dec. 28, 2007

Related U.S. Application Data
(60) Provisional application No. 60/877,480, filed on Dec. 28, 2006.

(51) Int. Cl. G06F 15/16

(52) U.S. Cl. 709/206

(57) ABSTRACT

This invention presents novel and simple, yet powerful, system and method for creating, organizing, sharing or distributing information via electronic means of communication, such as, e-mail, instant messaging, or electronic data transmission means.

The system and method offer a new way of addressing data security concerns. The system architecture is designed to give a user substantial control on the personal communication environment in addition to the system-wide security measures. Other innovations herein include novel use of flexible data structures to organize the information in the system database, use of familiar communication protocols for new functionality, and new method for efficiently gleaning information from many sources into a uniform structure.

This invention also provides a highly effective system and method of gathering precise “business intelligence” and other data for decision-making. Conversely, the system may provide to the user relevant information about products or services of interest.

### CROSS-REFERENCE TO OTHER APPLICATIONS

This application claims priority from the Provisional Patent Application, No. 60/877,480, filed by the same inventor on Dec. 28, 2006, and from a Provisional Patent Application filed by the same inventor on Dec. 28, 2007. The entire contents of these two prior provisional applications are incorporated herein by reference. No new matter beyond the disclosure of these two provisional applications has been introduced.

### TECHNICAL FIELD

This invention relates generally to information management systems and, more specifically, to systems, methods and computer programs for electronic data transmission, that may include legal gathering and display of business intelligence data.

### BACKGROUND OF INVENTION AND ART

With the ubiquity of the personal computers, electronic data transmission has become an essential ingredient of modern life. The protocols of electronic mail (e-mail), foremost example of electronic data transmission, have further evolved with the development of the Internet and the World Wide Web into electronic transmission of text and various formats of data via Instant Messaging, SMS and other mobile technology platforms, and now offer new capabilities for information sharing and dissemination.

As the Internet, nicknamed “Cyberspace,” develops into a repository of community or personal information to be shared or retrieved for further use, electronic data transmission and electronic mail continue to develop in new ways.

At the present time, Cyberspace is populated by a rich variety of applications, where users may store information to be retrieved for personal use or sharing. The calendar or event planning applications are examples of applications which permit “life planning” for an individual or a community of users. Other examples of applications on the Internet that utilize sophisticated transmission of electronic data are: MySpace.com, MSN Spaces, YouTube.com, Flickr.com etc. Many of these applications accommodate e-mail for sharing of comments between users, even though these applications may not employ e-mail as the primary means of communication. For instance, many news services or aggregators of news items on the Internet permit the user to share a news item of interest with friends via e-mail. The sharing of calendar events via the event planner programs on the Internet is another example of the use of e-mail for communicating comments with the organizers or the other participants of the events.

While email is undeniably widely used and useful, it is well known in the industry that e-mail remains one of the principal sources of spurious messages known as “spam” and of the proliferation of viruses, worms or other unwelcome and malicious invaders of a computer system. Considerable resources are diverted at the present time by users to control spam and reduce the threat of malicious code riding along with electronic mail. Although the end users are often given the option to filter out the unwanted or harmful messages, these measures often fail for a variety of reasons: End users may under-estimate a threat, be unprepared for it, or may simply be unaware of a particular threat and inadvertently pass it along.

It is also recognized in the industry that certain types of harmful messages are best controlled at the system level. However, the popular providers of e-mail do not necessarily and routinely check all e-mail messages for spam or malicious code either at the system level or in a consistent manner.

Many currently available communication applications permit retrieval and retransmission of information from the Internet; and, some applications also permit customization of such information. However, with the proliferation of these applications, there is now a need for systems to provide a secure and seamless environment for the collection, retrieval, processing, management, sharing, and distribution of information uniformly across platforms. From the users' perspective having uniformity of control not only imparts convenience and flexibility but also meets each user's diverse, unique needs more efficiently.

By making use of novel “intelligent” information processing, the present invention addresses the problems associated with electronic transmission of data outlined above: it achieves the uniformity of interface and ease of use combined with improved security of personal data and spam control. In addition to the system-wide security measures, the system of this invention is designed to give a user substantial control on the personal communication environment.

A key advantage of the system architecture of present the invention, indeed, is the manner in which security is addressed, and therefore the manner in which spam and other unsafe messages may be treated by the system.

The system uses the familiar protocols similar to e-mail for all the tasks related to the organization of personal information as well as for retrieving or sharing personal information or public information available on the Internet. The advantages of this scheme for the user include security of personal data, a uniform interface and ease of use, and, for the service provider they include a greater control of the overarching concerns, such as access control and security.

The utility of online space, both as a suitable advertising channel and as an effective tool to gather information usable as “business intelligence” for appropriate decision-making is gaining acceptance, but the optimal way to harvest such information has not yet been devised. The system and the method of the present invention provide a very effective tool to gather and present such information, both to serve the individual user's interests and, with the collectivized and processed information, for the businesses to make suitable decisions.

### BRIEF SUMMARY OF THE INVENTION

The present invention provides a simple yet powerful and cohesive system and method for creating, organizing, sharing or distributing information via electronic means of communication, including but not limited to, traditional and mobile versions of e-mail, instant messaging systems, or other internet or web-based communication means. The system and the method are envisioned to apply to the communication means in existence now or to be developed in the future.

The major innovations of system of this invention include: A judicious hierarchy of appropriate, interlaced, system-level and user-permitted access control structures; linked maintenance of all data and information associated with a User; a novel use of flexible and broadly employable data structures to organize the information maintained in the system database; novel use of the familiar communication protocols; and, the provision of the structures and functionality dedicated to efficient fulfillment of information requests.

The system of this invention is conceived with a view to shareability of information ab inito; therefore, it enforces security check on each incoming message. This security check is characteristically made at the initial, high level and may be in addition to any user-instituted security checks. Since powerful resources could be brought into play at the system level, typically, far fewer spurious messages such as “spam” would reach the level of the user. Similarly, the patterns of certain messages containing viruses, worms or other unwanted or malicious code can be deciphered more easily at the system level, and appropriate system-wide measures instituted to neutralize or contain their damage. Since security is integral to the architectural design of the system of this invention, rather than being an afterthought, this system has the capability to provide superior security features compared to existing electronic mail services.

The embodiments of the invention described herein allow the security checks to be systemically applied at multiple levels. Other contemplated embodiments may offer the capability to quickly switch the security levels and algorithms in real time to suit the needs of the user community, or to efficiently re-allocate the system resources in the face of a particular threat.

The system and method of this invention utilize a specialized Application Processing Interface (API) tool which is used to collect and transmit bits of electronic information. This involves wrapping the information with a set of instructions or metadata that indicate the source of the data, the user's localizing information, the user's “intended” action for the information, and other identifying and control properties of the data.

The architecture of the system is conceived so that the metadata wrapping the transmitted information may be re-defined and re-specified to efficiently respond to the system exigencies and the needs of the user community.

The overall system envisioned by this invention is termed “inoof,” or “iNoof” system, and the processor described and referenced herein as “noofsys” or “NoofSys,” is a principal component of the inoof system.

NoofSys enables a user to send or receive, or to process or manage, information conveniently from within one “account” regardless of whether the “information” is created by the said user or obtained from a group close to the user or a public source on the Internet. Accordingly, such information may be as personal as a “to do” list of errands or of such wide interest as a current news item. NoofSys recognizes a “user” account with its built-in access or “permission” levels. These permission levels are used as part of the “intelligent” processing of incoming data: Based on the level of permission granted to the user NoofSys may collate or link this information in the user's account, or other users'accounts, according to the user's instructions or it may trigger other appropriate events or actions on the content indicated by the user's or system commands.

Besides using a sophisticated “permission” or access hierarchy, a key part of inoof is the way data is organized: NoofSys organizes the collections of objects as “lists,” although alternative data structures may be used. Thus, for example, a to-do list or a grocery list is a list, but also a calendar is a list of events; a photo album is a list of pictures, a portfolio is a list of stocks, a sentence is a list of words, a paragraph is a list of sentences, a story is a list of paragraphs, and so on.

The data structures contemplated in this invention, including Lists, permit the user to persistently maintain information during the course of their system usage, for example, for personal use, sharing or dissemination. These lists made by the user on a site of the system of this invention are of various types, including shopping, to-do, notes, contacts calendar and so on. A typical user adds items to these lists over multiple communication channels, such as, mobile device, email, instant message (IM), text messaging (SMS), or while browsing a retailer's website.

These lists, which can be displayed, and retrieved over such multiple channels, may eventually morph into web “pages” that capture very detailed information about the users and/or the items of their interest. This information may be used with user's permission through the “permission” process inherent in the technology of the iNoof system for many business purposes, for example, to gather collective statistical data or to display highly targeted business messages and advertisements.

In order to enable the utility for business information and “intelligence” gathering and display, iNoof may be augmented with a part that gleans and processes context-sensitive information from the users' lists. Depending on the sophistication desired, such processing may occur in a dedicated part of the system. The analysis of the data may be carried out with the help of a string of special purpose engines that generate and display the information for the use of the individual user; or, it may collect, collate and/or aggregate “business intelligence” information for display or use for decision-making by business consumers. Since the permission structure of iNoof gives access controls to the user, such data would typically be collected according to very precise instructions of the user, albeit in an automatic, non-intrusive manner.

Finally, although “e-mail” is indicated to be used as a principal means of electronic data transmission in this description, the word “e-mail” should be read as a stand-in for the general transmission of electronic data. It should be apparent to a practitioner of the art, that NoofSys is capable of uncomplicated extension to the transmission of a variety of electronic text or non-textual data.

### BRIEF DESCRIPTION OF THE DRAWINGS

The drawing figures present the overview of the architecture of some illustrative embodiments of the present invention.

FIG. 1 is a block diagram of the processing of an electronic message by NoofSys.

FIG. 2 is a block diagram of the processing by the component known as “Noofmobile” of certain types of requests, such as, a request for information, or of a message on a mobile platform.

FIG. 3 is a high level view of the system architecture of one embodiment of the invention, showing NoofSys relative to the other system components. The components of NoofSys are shown within the broken-line box, shown outside of which are the typical components of the Internet with which NoofSys communicates.

FIG. 4 is another depiction of the system architecture showing only the parts of an internet-based system essential to NoofSys, and leaves out many of the standard features of a typical internet-based system within which noofSys may be embedded.

### DETAILED DESCRIPTION OF THE INVENTION

The present invention provides a simple, yet powerful, cohesive and uniform system and method for creating, organizing, sharing or distributing information via electronic means of communication. These communication means include traditional e-mail, mobile versions of e-mail, instant messaging systems, such as IM or SMS, or other internet or web-based communication means. The flexibility of the system and method of this invention allows ready adaptation to new, internet or web-based communication means, and the invention contemplates application to electronic means of communication now in existence or to be developed in the future.

The overall system envisioned by this invention is termed “inoof,” or “iNoof” system, and the processor described and referenced herein as “noofSys” or “NoofSys,” is a principal component of the inoof system.

The key innovations of iNoof include: Advanced security features based on a hierarchy of appropriate, interlaced, system-level and user-permitted access control structures; Efficient memory cycles realizable through a linked maintenance of all data and information associated with a User; Novel use of flexible and broadly employable data structures to organize the information maintained in the system database (e.g., use of “List” data structure); Novel use of familiar communication protocols (e.g., e-mail) for several internal and external communications; Provision of specialized structures and functionality dedicated to efficient fulfillment of information requests (e.g., the “Get” function); and, Provision of structures and functionality to carry out requests for “physical” actions (e.g., the “exec” function) that may be combined with the non-physical requests.

The architecture of the iNoof system directly addresses the security issues of the electronic transmission, and uses effective methods for the control of spurious email or “spam.” This is achieved by supporting the application of sophisticated system-controlled as well as user-controlled security and access features at multiple levels and stages of the processing of the messages.

The power of iNoof system derives from the modularity of several scaleable and re-configurable components and the coordination and cooperation of the system-level and user-level treatment of electronic messages. Furthermore, providing an architecture that employs transparent, parallel interfaces for email and mobile applications enhances the simplicity of the system from the user's perspective.

The terms “user,” “User,” and “account owner” used interchangeably in this description, and may in certain contexts include the terms “sender” or “recipient.”

The method of the present invention is distinguished from traditional emails for security purposes in the way emails are handled from the outset: Unlike the traditional email programs, the emails in this invention are not “opened” by an email client prior to the processing by the system. The content of the email is processed by iNoof system before it is presented to the recipient of the message, including appropriately scanning any attachments. This scheme assures a high level of security for the individual user. Therefore, the recipient of the email runs a far lower risk of executing or downloading email-borne unwanted, harmful or malicious code, such as, viruses, worms, adware, spyware, Trojans, keyloggers etc.

The processing of the electronic messages by the system prior to receipt by the end user contributes to help control spam in three important ways: 1) Unlike the typical email services that send down the email messages to the recipient “physically” as they receive them, the incoming email messages of an inoof account owner are “virtual” messages; 2) The requirement of a valid code (i.e., noofList, defined below), which is set by the account owner, to correctly process an incoming email ensures a low probability that emails not intended for that user will make it to the user's account; and, 3) The non-direct route to the user's account makes it an unattractive target for potential spammers. Invalid requests, or mistyped valid ones, go into a “Miscellaneous” noofList, which can be turned off by the user.

As noted above, among the key innovations of this invention are the use of flexible and broadly employable data structures to organize the user-centric information maintained in the system database and the support of the functionality for efficient fulfillment of information retrieval requests. For example, iNoof uses “Lists”, with appropriate permission levels to maintain all information associated with the User, and the “Get” function for rapid retrieval of information, be it from these Lists, or the other local databases or from the Internet.

Lists are recognized by their types: Examples of common list types include, “todo,” contacts, calendar, expense report, inventory, categories of news items, etc. The modularity of the architecture ensures seamless introduction of new List types as needed. The system and method of this invention utilize a specialized Application Processing Interface (API) tool, which is used to collect and transmit bits of electronic information. This involves wrapping the information with a set of instructions or metadata that indicate without limitation, the source of the data, the user's localizing information, the user's “intended” action for the information, and other identifying and control properties of the data. Here, the user, for example, may be the sender or the receiver of information; the user's localizing information may include, but not be limited to, the user's geographical or physical location, the time, or the contextual location such as the “web page” or “click trail” of the user at the time of transmission; user's “intended” action, for example, may be to store the data, to share it, or to use it to modify existing data; environment of the source of data may, for example, be an email message or a content provider identified as such in the metadata wrapping the data.

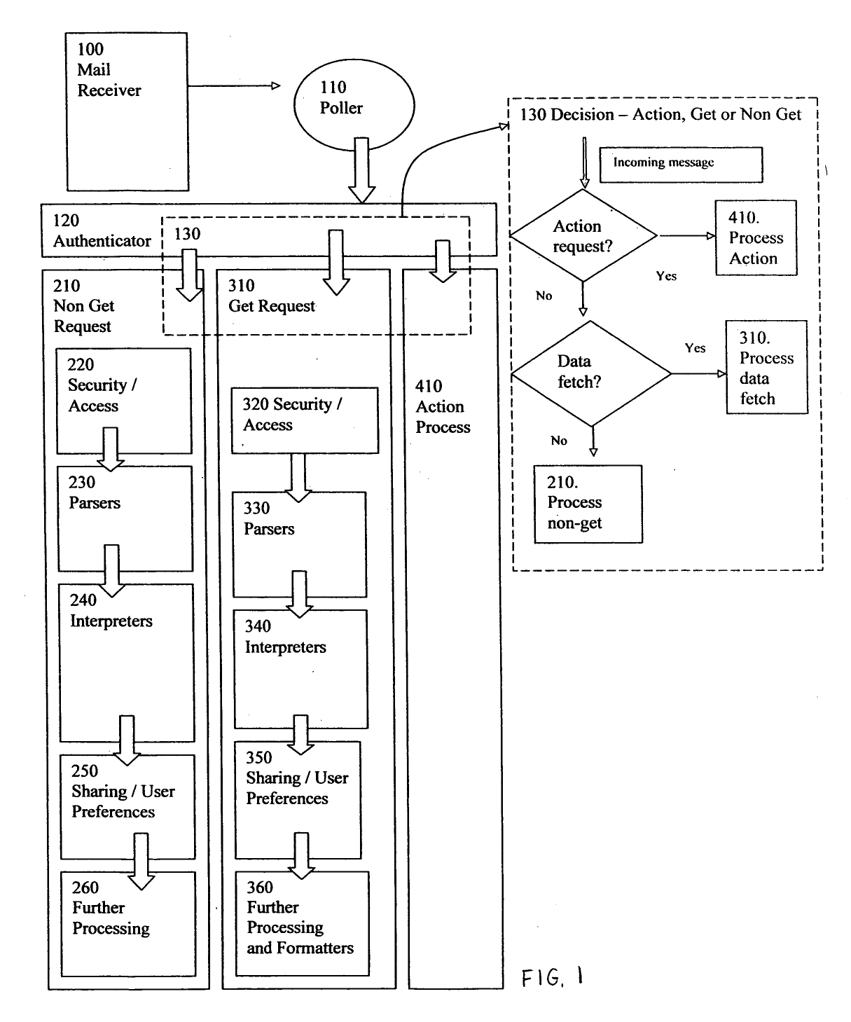

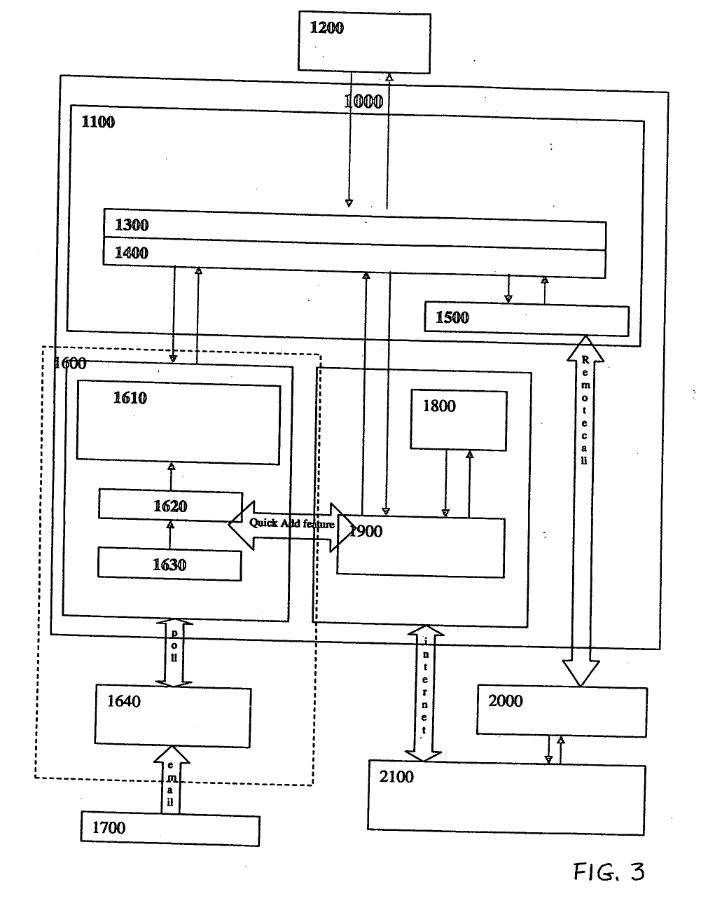

A block-diagram depiction of the processing of an electronic message by NoofSys is shown in FIG. 1. This process is also shown in FIG. 3 as part of the overall system architecture in a typical configuration wherein the part relevant to noofsys is enclosed within a box with broken lines.

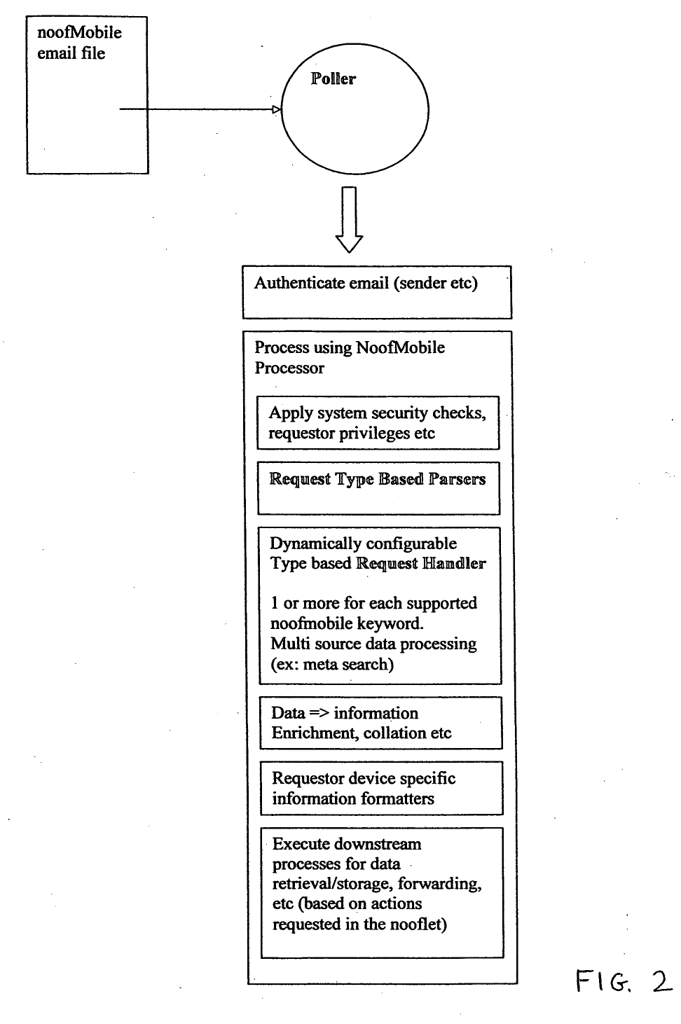

FIG. 2 shows the processing by the “NoofMobile” component of a user's request for information.

Each message, when received by the iNoof system, with the possible exception of certain administrative messages, is initially directed to a catch-all “mailbox” or “Mail_Receiver” component where the message is found by a system component, known as the Poller, by either routinely polling the catch-all mailbox or via an algorithm that automatically directs the messages to the Poller for processing at prescribed intervals. It is also possible for the “Poller” component to be omitted in an embodiment of the invention, for example, wherein each message in the catch-all mailbox may be directed for further processing as it is received.

From the Poller the message undergoes the following processing steps: (1) Determine the User to whom the message is directed; (2) If said User is not determinable by the Poller, then direct the message to the Exception Handler component of the system for appropriate processing; (3) Determine the access and shareability levels associated with the said User; (4) Apply the security checks in accordance with the access and shareability levels associated with the said User; (5) Parse the message to identify the type of List or Lists that the message will affect; (6) Forward the message for storage or further processing.

Processing of the message at step (6) above may involve putting the message on one or more queues depending on the type or number of List or Lists affected, or on the types of origin of the message, or a combination of thereof. The further processing of the message may be carried out by multithreaded system components.

The execution of the steps (3) and (4) is compatible with the concept of addressing the security issues before the user receives the message. Step (5) embodies the concept of “List” that is key to the organization of inoof system.

After the step (6) shown above, the Poller may apply the user-specified security checks on the message and then add the message to the List identified in step (5) in one embodiment of the invention; or in an alternative embodiment it may append the message to the List first and apply the user-specified security checks subsequently. The order in which the steps (3) to (6) are performed is not fixed; other embodiments are envisioned within the scope of the invention wherein the steps (3) to (6) are performed in different orders, or where the steps (3) to (6) constitute repeated, iterative loops, depending on the lists affected, the access and shareability levels demanded by the user, or other system- or user-specified criteria.

From the Poller the message is forwarded to a Parser that in turn is followed by an Interpreter. The Parser may be specific to the type of List identified in step (5) so as to isolate from the message the properties applicable to the List. The functionality of the Interpreter includes intelligently decoding the instructions to discern the action “intended” by the user or the sender of the message. The Interpreter is envisioned to allow the instructions to be user-friendly and convenient to use, in as close to “natural language” as possible. Therefore, it comprehends that the capabilities of the Interpreter may expand in response to development of new technologies.

The parsing scheme may permit initial, basic parsing to be common to all requests that share certain features, for example, the source or destination, the communication channel or device etc. The modular architecture is contemplated to allow for easy plugging in of new or updated parsers and for re-configuring the system to use the same.

The Parser and Interpreter may be implemented as two separate components of the system, or as one combined system component with parsing and interpreting tasks allocated to its sub-components in such a way as to allow iterative parsing and interpreting, or in another configuration in order to improve performance or to conservatively expend the computing resources.

Together, the Parser and Interpreter break the message subject and body into various tokens and interpret the predefined tokens. In some embodiments of the invention, the attachments with the message may be broken into appropriate tokens as well. The tokenization and interpretation may also depend on the List identified in step (5). In addition, some embodiments of the invention may incorporate within the parsing and interpretation scheme the information regarding the message boundaries and the possibility of successive messages chained from the message being decoded.

After deconstructing the message into an appropriate structure, NoofSys may store the message in the “Mail_Store,” persistent storage suitable for later recall or further processing at a later time. The message may be further enriched by applying the user's preferences at this stage, either prior to or following the storage of the message. The “Mail_Store” is contemplated to be a scaleable component, from a simple mail file to a networked collection of dedicated servers, depending on the needs of the message traffic. The component is referenced herein by the following descriptors synonymously depending on the context: “Mail Store,” “Mail_Store,” “mail_store,” “mail store,” “mailbox,” or “mailfile”

The further processing of the message may involve a unique and powerful feature of NoofSys, namely, the “Get” request. Get, or another suitably descriptive word, may be retained as a reserved word by inoof to instruct the system to carry out the following processing steps:
(1) Check the “access and share” settings of the recipient of the message—to establish the appropriate access to the List or Lists indicated in the message;
(2) Procure the information associated with the List or Lists indicated in the message;
(3) Get the results, potentially including enriched or modified data, back to the sender of the message.

A typical Get request in a typical embodiment of the invention may be recognized by the form of the request, for example, info@inoof.com.

The “Get” function allows NoofSys to carry out several diverse actions to get information, such as to retrieve a personal information List by the User to manage the List, or to append or delete items from a list of collected news stories from the web. The Get function may be invoked by the system for some request types without an explicit reference to a “Get” request.

The Get function permits the system a unified and uniform view of information from multiple sources. Such sources may include the User (for example, for personal reminders), the User's personal family members (for example, for updating information on a shared List of the familial type, such as household inventory or genealogy record), the User's business collaborators (for example, for records of a business committee) or the World Wide Web (for example, for a specific weblog or “Blog”).

It will be readily seen by a practitioner in the art that the sources and examples for List and Get given above are only illustrative, and that the notions of Lists and Get can be extended in response to the number of types of lists, the number of sources from which information needs to be collated into the lists, and the number of types of requests anticipated by the users of the system. The notions of List and Get can also be extended in an obvious manner in response to other criteria if new sources of information are introduced by new technology in the future.

Another unique and powerful feature of the Inoof system is the ability to process messages that cause certain actions to take place within the system or in other components or systems connected to Inoof system or systems that use Inoof compliant technology. For example, a message could be sent by a user with a keyword such as “exec,” with a command and suitable predicate indicating the physical action the user wants to execute. Examples of such a message are “exec start webcam” or “exec turn on home lights”, which when processed by an iNoof compliant component, possibly remotely, will start his web camera or turn on his home lights in a suitable environment.

The architecture of this invention takes advantage of the possible similarity of the processing of “execute” type functions to the processing of a “get” function. Thus, it envisions that

the processing of “exec” type messages may use many of the same components as the “get” as well as the default flow of the Inoof system, even though the former type of messages generally execute, or cause to execute, some actions which could be physical in nature and made possible by electromechanical controllers and converters etc.

Apart from the processing efficiency and a more elegant interface for the user, this scheme permits the use of “execute” commands to carry out “non-physical” actions (e.g., broadcast some information to a large number of parties) or combine physical and non-physical actions or components in a natural, intuitive manner via one command (e.g., to turn on a series of screens and display a warning on each of them).

NoofSys allows a user to get specific information, for example from the Internet, by requesting a subsystem, called “Noofmobile,” represented in FIG. 2. Noofmobile processes certain requests, such as, the Get requests for information or other specific instructions for a physical action to be carried out by a part of the inoof system or by a part of another system linked to inoof. A typical Get request in a typical embodiment of the invention may be recognized by the form of the request, for example, info@inoof.com.

The processing of the requests by Noofmobile is similar to the processing of messages described hereabove.

The separation of the information dispensing component, i.e., Noofmobile from the other message processing components begets two principal advantages: first, it allows for a more efficient processing of the information requests handled by Noofmobile as well as of e-mail messages; and second, it allows for dynamic reconfiguration of the system, and Noofmobile component in particular, in response to certain requests, e.g., based on their frequency, the needs of the user groups or other implementation-specific criteria.

Having described inoof and NoofSys in general terms, we next provide a more specific description of the system and the method of this invention. Any examples provided in the specific description are non-limiting, and used only to elucidate the manner in which a practitioner in the field may implement specific embodiments of the system.

Some definitions are introduced at this point to facilitate the discussion. The proprietary stems “noof,” or “Noof” form part of several of these definitions and keywords. When one of these stems is incorporated into a keyword, with or without other characters, it refers to a commonly understood system term or component as used or implemented in an embodiment of the present invention.

A “Nooflet” is a piece of information or data that is either sent to or from the system of this invention, or communicated from one part of system of the invention to another part of the system. A “part” of the system in this context may be implemented in hardware or software or a combination of hardware and software, or a “part” of the system may be functionally described. A “part” of the system, for example, may be a repository of information within the system, the service account of an end user, or it may be a part of any of the pipelines connecting the origin and the destination of information.

The transitive verb “to noof” means any one of the following depending on the context: to send, receive, request to receive, store or retrieve, or to otherwise communicate, or process for communication, a nooflet to, or from, any part or component of the system. The definition of “to noof” also subsumes the interim processing of a nooflet by the system during the course of any of the above listed actions. Noofing is possible by human users, or by computing machines or elements, or by automatons. Users can noof their own accounts or other users' accounts, or the system; the system can noof any of the users as well as itself. Thus, “to noof” as a verb is used to collectively refer to the actions possible on a nooflet during the course of communication.

Collections of nooflets may be maintained in a variety of data structures suitable for noofing. For example, information may be maintained in lists, tables, spreadsheets, multilinear ordered sets or some other database construct depending on the type of information stored and the efficiency with which it can be accessed.

The list data structure may be suitable for the most diverse types of applications. In this sense, list data structure for maintaining information for the purpose of noofing is the “best” mode of practicing this invention.

Herein, the descriptive word “list” is used in a broad, generic sense, as a “linearly ordered” set. Thus, for example, a calendar is a list of events; a photo album is a list of pictures; a portfolio is a list of stock holding; a recipe is a list of instructions involving a list of ingredients; a sentence is a list of words; a paragraph is a list of sentences; a story is a list of paragraphs; a video is a list of frames; and so on. Each of these lists has a beginning, and an end, and a finite, though possibly unspecified, length. The linear order of each List permits sequencing of the items in the List. The List structure is flexible and applicable to any collection that needs data to be maintained, or any operations to be carried out, sequentially.

A list of nooflets is a “Nooflist.”

“Noofmail” is an incoming or outgoing message to or from or within the inoof system. E-mail as received by iNoof for processing is an example of noofmail.

As described above, inoof system includes a component, akin to a catch-all “mailbox,” to receive messages other than those messages that are directed to corporate or reserved addresses, addresses such as support@inoof.com, sales@inoof.com etc. Also as stated above, from this component the message is received by “Noofmail Poller” for further processing.

For quick answers to certain very frequently asked questions or for quick fulfilling of very frequent information requests, the system provides the “Noofmobile” component.

Examples of such requests are the weather conditions at a specified place at the specified time, movie listings in a certain metropolitan area or the latest news item about a topic of wide interest. Efficient processing of these types of requests may be achieved by providing dedicated type-based “handler” modules mediated by Noofmobile.

Fetching of the information of this type by the “handler” module may then be delegated to a number of dynamically configurable data “helper” elements. This allows all components of the service to be reconfigured very quickly to meet demand. For example, if there is heavy demand for a certain news story that is carried in better detail by an outside news provider than the regular, default system or news partner, then the system could be reconfigured to switch to the new provider very efficiently.

In addition to such system level reconfiguration, inoof system allows user “preferences” to be set or configured by the users at the level of their individual accounts. These preferences may, for example, apply to the “look and feel” of the messages, or to the priorities of allowable message content, or other features placed by the system under user control.

Practitioners in the art will readily see that other modes of data communication, such as the information exchange via the World Wide Web, instant messaging, asynchronous or synchronous chat sessions etc., may be handled by the inoof system in a manner analogous to either Noofmail or Noofmobile as described above. Moreover, the architecture of inoof system lends itself to extension as new communication channels and technologies are introduced in the future.

A component of the iNoof system may be used to display targeted, context sensitive ads and additional information for items in the users lists. For this application, the system may include engines that, among other methods, crawl the web for many types of relevant information about the items in the list; it then processes and/or enriches the data and presents aggregated information to the user (“hyper-aggregation”).

The aggregate “wanted” data shared by the users via their accounts, including lists, user generated content and more, is contemplated to be processed by business intelligence engines and may provide valuable information to service providers and retailers. The engines may also perform synchronous and asynchronous tasks for actionable items in the lists, such as performing a deep search and consolidating the results for the user.

Certain user activities may trigger action by this component of the system. The following are examples of such user activity:

### Add Item to List

The user can add the items to their lists (or shared lists) over multiple channels such as the web, email, instant messaging or mobile messaging and more, as described above. The “item” added may be a product that the user is interested in buying/selling, or a service needed or some other actionable item. Other items may be implicitly “added”—for example in the photo albums or contact list.

Use Context Info for the User to Interpret What they are Looking for—Product/Service/Actionable Event

The user typically adds items to specific lists. The advantage of this method over existing contextual searches is that the context/intent of the user is much more clearly defined. Moreover, because the user typically has a profile with iNoof, as well as data in other user lists, iNoof may have the ability to build a better profile of the user, which in turn can be used to more effectively target advertisements and services directly or indirectly to the user. For example: a web search for “beatles” returns thousands of results related to Beatles (music), beatles (bug), Beatles (car). This is because the search engine doesn't know what the user is looking for. This type of non-specificity reduces the effectiveness of the ads displayed, and leads to higher costs and lower click through rates for the advertisers.

In iNoof, each of these will be on different lists or pages devoted to that item (second hand car buying example). This provides a clear indication of the intent and context. It also gives and indication of the timeframe in which the user may want to take the specified action (example: the user wants a camera by Xmas). More context information can be gleaned from the users profile and related lists. Example, if the user has indicated that they are a native of another country, or iNoof determines the same by noting that the user sent gifts to another country by using a service on the gift list, then iNoof could also display other similar services on the user's other lists. Example—services for sending gifts to India, and photo printing services that deliver in India, and even money transfer services could be presented to the user. In addition, iNoof could possibly enhance the user profile by information gathered from other public and private sources where needed.

Thus, in contrast to the other methods, the method and system of the present invention provides a more “intelligent” way of gathering business intelligence for better results and lower costs by building a better picture of the context and intent, which can then be used to target the user more effectively.

In preparing the request for the matching engine, for example, the System may collect the relevant contextual data from various sources, including the non-traditional data from the web—reviews, blogs, coupons, comparison info, user generated content sites, user profile and other user related data, localized information etc.

As iNoof interprets this data, it may process and digest it and present a unified picture to the user, as well as items of interest to the user, such as incentives from the retailers or providers. On the other hand, the system is capable of presenting information, such as, aggregated demand and demographic information to retailers, subscribers or providers.

The invention envisions that the form of these lists could vary based on the channels on which they are made or displayed in. The key areas in which the technology of this invention surpasses the other contextual ads are:
(i) This method has the capability to provide a deeper and richer context, which may lead to more accurate ads being associated with the items. The intent of the user is by design more focused and clearer.
(ii) The system captures what items, goods or services are actually wanted by the user, together with the time period of their interest. In particular, the time dimension of these items is typically not captured by the ad systems in current use.
(iii) Since the requirements are clearer/specific in the case of iNoof, it can also display integrated actionable “service ads”. These ads/links/actions may integrate context information so that the user is able to seamlessly execute a related service/action from their lists/pages. (Example: photo printing from the photo lists—the user's printing preferences, service provider profile, payment information etc. will be integrated in the background, so that a few clicks or even execute instructions via email etc. is enough to process the action. The process can serve as, say, the nearby Walmart's photo services accessible as a network printer for the iNoof user.)
(iv) The specific context information allows for a higher level of automation for integrating other services for the user. It also allows users to be individually targeted by highly customized ads.

The following examples illustrate how the system and method of the information collecting component may work in a few concrete situations.

### EXAMPLES

Camera shopping: Say you want to buy a digital camera by Christmas. You conveniently add it to the shopping list on the INoof Portal via your mobile device, email, instant message (IM), text messaging (SMS), or while browsing a retailer's website. When you view your shopping list, iNoof will display useful and targeted information about the product you want to buy, such as deals/coupons, special offers from retailers that could reduce your purchase price, integrated options to purchase it from within the portal, review digests/summaries, recommendations and more. Meanwhile, retailers that have subscribed to the INoof Business Intelligence data will get valuable information such as “200 users in zip code 01824 want to buy a digital camera by Christmas” and the like.

Asynchronous research: a student wanting to research a specific topic could add it to their “research list” on the Portal. This list would be served by an asynchronous meta/deep search engine that would present a unified context-sensitive report to the user, with text/images/video and more.

Photo album: a user may create a photo album and add many pictures to it. Other users could add to shared albums, and iNoof may also show service ads for these albums. Services could include photo printing for the albums, external photo sharing/distribution services etc.

Contacts (address book): contacts in the users Contact list could be enhanced with information from other people related sites, such as LinkedIn, Facebook, photos from the web etc.

These examples are given here for illustrative purpose only. Practitioners in the art will readily see the utility and methodology to use in other situations.

To return now to explain the basic iNoof system, with a non-limiting, concrete illustration, the treatment of a message by Noofmail is depicted in FIG. 1 as a block diagram. The functionality of each numbered block in FIG. 1 is explained in order below.

All messages for user accounts are received at Block 100:

### 100. Catch-All Mail Receiver

All emails or messages, other than the inoof corporate mail and other reserved mailboxes, are received by this system component and held for further processing.

### 110. Poller

The Poller either polls the mail store periodically or receives updates, periodically or when new messages are placed in the mail store. The Poller forwards the message for authentication and further processing, and may queue the messages for dispatch to the Authenticator to be followed by noofProcessor boxes 210, 310 or 410.

### 120. Authenticator

The Authenticator component “authenticates message” which includes checking the message header to determine that the system recognizes the sender, that the sender has appropriate access authorizations and to check other validating information for the message before it is forwarded to one of the processor boxes 210, 310 0r 410.

### 130. Decide if Message is an “Action”, “Get” or “Non-Get” Request

The noofProcessor boxes 210 and 310 handle respectively the “non-get” and “get” requests; box 410 is provided for execution of “action oriented” requests (e.g., to start the operation of a machine or to remotely instruct the house lights to be switched on) that do not involve a List and do not fall into either the “Get” or the non-Get types of requests discussed above.

If the request is not an action oriented request, then the system may next check to see if it is a request for information, i.e., a get request. If the request is neither an executable “action,” nor a “Get” request for existing information, then it may be processed as a non-Get request.

### 210. NoofProcessor for “Non-Get” Request

If the request is neither a “get” request for existing information nor an executable “action,” then it may be assumed to involve a noofList and directed for processing as a non-Get request to box 210.

220. Application of iNoof Sharing and Security Procedures

### Sharing/Access

This component determines whether the message has the necessary access to perform the operations as contained in the message on either the receptionist's account or on the specified lists or list items etc. For example: the owner (recipient) may want to receive some types of emails only from specified contacts nooflist, for example, family members.

The system may expect the sender of the message to know the correct nooflist to affect the correct list. Otherwise, if the system is unable to determine the correct nooflist, then the nooflet will be directed to the recipient's Miscellaneous nooflist, which the recipient has the option of turning off. This is one way the user may control access to messages to or from the user's own account. By allowing other people to noof them, the owners are enabling sharing of the noofed data with them.

The system supports the application of security and access features at multiple levels, such as, the user-level, nooflist level, nooflet level. The security and access features may also be applied at the channel level, for instance, by allowing access to web messages but not to instant messaging.

### Security

As noted above, the messages such as email not “opened” by an email client in the manner of traditional emails. Therefore, the iNoof recipient of the email runs a minimal risk of executing or downloading email borne unwanted, harmful or malicious code, such as, viruses, worms, adware, spyware, Trojans, keyloggers etc. Since the content of the email, including appropriately scanning any message attachments, is processed by iNoof system before it is presented to the recipient, this scheme assures a high level of security for the individual user.

### SPAM Prevention

As stated above, there are three ways in which this invention better addresses spam prevention than existing email services: 1) All incoming emails of inoof account owners are caught and processed before receipt by the account owner or user; 2) A valid noofList code, which is set by the account owner, to correctly process an incoming email ensures a high probability that only emails intended for that user will make it to their account; and, 3) The non-direct route to the user's account makes it an unattractive target for potential spammers. Invalid requests, or mistyped valid ones, go into the Miscellaneous nooflist which can be turned off by the user.

### 230. Pluggable and Re-Configurable Parsers

This box shows pluggable or re-configurable Parsers based on the types of requests, Lists affected or other criteria designed to enhance the efficiency of message processing. The Parsers provide subject and multi-line body support and may also use other properties of the message, such as the headers, for additional information.

The syntax of nooflet parsers is designed to be able to support other message features, such as, specific content in the email body, a variety of MIME types, the provision for multiple nooflets (i.e., “adds” to a list) in the same email message, and so on. Email attachments are also supported by parsers of this type, as are HTML based emails and emails in other formats. The modular architecture ensures that these examples are illustrative and non-limiting. It will be apparent to a practitioner in the art that suitable Parsers may be developed and incorporated within the inoof structure in response to formats to be developed in the future.

### 240. Pluggable and Re-Configurable Interpreters

This box shows pluggable or re-configurable Interpreters based on the types of requests, Lists affected or other criteria designed to enhance the efficiency of message processing

The parsers and interpreters aim to allow the user to interact with the system in natural language as much as possible. For example, the request “calendar birthday party next weekend” may obtain a translation of the string “next weekend” into the appropriate date of the birthday party in user's calendar and generate a nooflet containing the same information.

Sophisticated interpreters to handle complex linguistic constructs, voice recognition, and picture or video content via attachments, etc. are contemplated in other embodiments of the invention.

A Default Interpreter is used to process the message if no other interpreter is found suitable for an unexpected nooflet type. One of the functionalities built into the Default Interpreter is to separate inadvertent errors in noofing from spam by utilizing appropriate queries, dialog, or other sophisticated techniques. This approach provides another line of defense against SPAM.

An important capability of the inoof system is that nooflets can be nested or chained, whereby one or more nooflets may, in turn, lead to more nooflets. For example, as part of the reminder feature in the calendar nooflist, a user can be emailed a reminder to the email of their choice. If the subject of the reminder is provided in the appropriate noofing syntax, the reminder email content itself becomes a nooflet.

As a concrete example, suppose a user requests a reminder close to the expiry of a 0% APR credit card offer, an event on the user's calendar. Suppose further that the reminder is configured to go to the user's inoof email address, where it appears with the subject similar to “todo Pay off credit card 6574 balance by August 15”. Here, todo is the user's nooflist code, and the date August 15 may come from a dynamic substitution of DUE_DATE into the subject line. When this reminder is received by the noofsys, it shows up as a nooflet in the user's “todo” list automatically. Many levels of nooflets can be chained in a similar fashion to allow for collaborating, synchronizing and reminding functions as well as for asynchronous communication.

### 250. Application of User for Preferences Security/Sharing/Retrieval

### Sharing/Access

This component applies the account owner's preferences to determine whether the email has the necessary access to perform the operations indicated in the email. By allowing other people to noof them, the owners are enabling a form of sharing.

### 260. Further Processes

Execute further, downstream processes for data storage/retrieval, forwarding, noof-chaining etc., based on actions requested in the nooflet.

The nooflets may be stored and/or forwarded to other destinations within or outside the inoof system.

### The Processing of “Get” Requests

If the request is determined in the decision box 130 to be a “get” request, then it is directed to box 310 for processing. The boxes 310 to 360 in FIG. 1 show the processing of the “Get” requests which follow a processing track parallel to the process shown above for the email messages. Thus, the functionality of boxes 310, 320, 330, 340, 350 and 360 is similar to the functionality of boxes 210, 220, 230, 240, 250 and 260 described above, although the underlying processing logic may be different. Other pertinent aspects of the processing are explained herebelow:

### 310. NoofProcessor for “Get” Requests

Noof “get” request invokes the use of NoofGet Processor. This component processes the requests to retrieve information from the inoof system, and its execution may involve additional access checks.

### 320. System Security Checks for “Get” Messages

The checks for ‘get’ are more stringent than those for the “adds,” and they apply at finer granular levels; for example, only the emails allowed by the user may get certain nooflist data, or to allow a “get” for some nooflists/channels/users or to allow only nooflets of a certain type or characteristics. The data accessible by a “get” can be restricted by using suitable, optional filters. The system may be set up to allow, for example, the user to get all contacts with the name John via “get ppl John”, where ppl is the nooflist code for the contacts.

### 330. Pluggable (Configurable) Request Parser

Parse the subject and multi-line body for the get request and pass the request onto the get interpreter in box 340.

### 350. Enforcer of User Preferences for Security/Sharing/Retrieval

This component ensures application of user's preferences for security and sharing, and for data retrieval.

### 360. Result (Fetched Data) Formatters

Formatting of the requested data may depend on factors, such as, the type of nooflist fetched, the device from which the request is made (phone, email or PDA email), the channel over which the request arrived (email/web/IM etc), and other meta information. This process is handled by specialized formatters.

### Processing of Other Types of Messages

If the message contains a request that is neither to “get” data from inoof system nor a “non-get” to modify a nooflist using the nooflet in the message but a third type of instruction such as the action type of request—(e.g., “exec” discussed above), then it is handled by the box 410 for further processing. As a particular case, the box 410 includes processing by Noofmobile.

410. iNoof Action Processors

iNoof action processors deploy based on noofed or processed instructions, and may include Noofmobile, physical action executors etc. Examples of action executors are to execute physical tasks given the needed connectors/components, for instance, turn on the lights at home or start a machine.

Box 410 may refer to collections of specific, interconnected hardware along with the appropriate sets of instructions.

The treatment of a message by Noofmobile, in particular, is depicted in FIG. 2.

Finally, explained below is the manner in which NoofSys relates with the public access networks, including the Internet and the World Wide World.

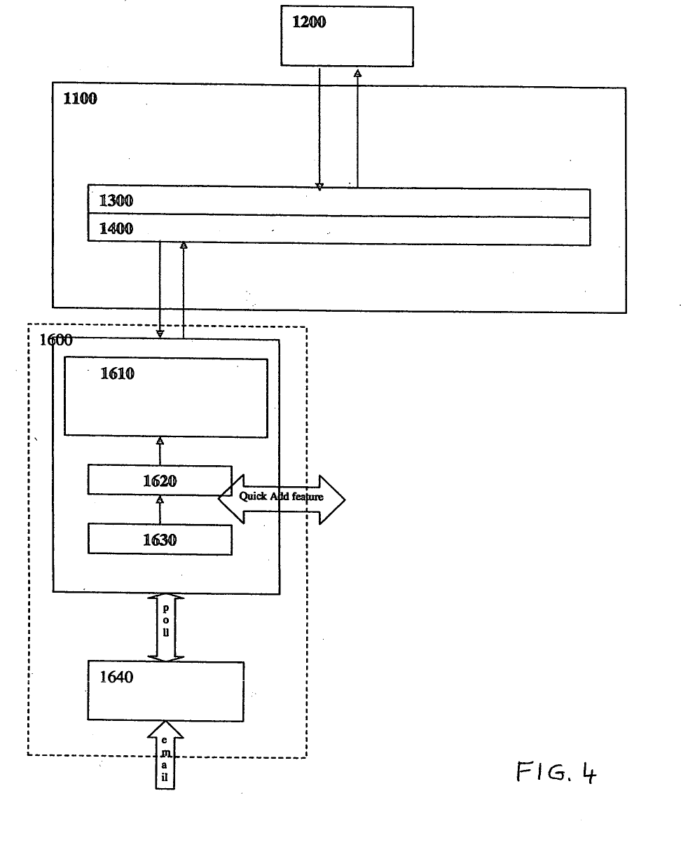

FIGS. 3 and 4 illustrate how NoofSys relates to the Internet or the World Wide Web. FIG. 3 shows a high-level system architecture in a typical configuration, with the part relevant to noofsys enclosed within a broken-line box. FIG. 4 shows another high level depiction of the system architecture wherein the parts essential for an implementation of noofsys are shown; this drawing figure does not show the common and standard features of an internet based system with which noofSys typically communicates.

In the description of the system architecture herebelow, it is assumed that an “Email client” is any client capable of sending an email to the system server or servers. “Mail Store” in this description refers to the persistent storage for the emails coming into the inoof system that allows storing and retrieval of emails. This storage could be from a simple mail file to a sophisticated database, depending on the overall needs of size or efficiency requirements of the specific installation. This component will typically be a fault tolerant system with the capability to self-recover in the event of system failure.

“Core Server” as referred herein is the main inoof application processing interface layer that processes a message into its components, such as, the nooflets and nooflists {Core Server comprises business logic, a database access layer, caching and other components that permit inoof specific functions described above. Upon processing of the message the data is stored in a database (for example a MySQL database).}

The web related components of the system are housed in a component herein called the “Portal Server.” The Portal Server may physically consist of separate components as needed for the purposes of scaling, performance and modularity.

The email, web and other channels (“Quick Add” for non-get or get requests) use the same underlying processing modules for noofing on the backend; for example, for the embodiments, depicted in FIG. 3 and FIG. 4. This commonality of processing may be achieved, for instance, by extracting and transforming information from one channel into a form that is suitable for the processing of the other channels. This architecture allows several common business logic components to be used for the processing of the nooflets generated by any of the supported channels.

The specific components of the system shown in FIG. 3 and FIG. 4 are as follows:

1000. World Wide Web server used to run the inoof system. The system can run on one or more instance of this or other types of web or application servers.

1100—iNoof Core Server—The Core Server comprises the bulk of the Application Processing Interfaces that provides the core system for processing information and business logic.

1200—Inoof Data Store—Inoof Data Store is the database, or collections of interlinked databases used by the system. An example is the MYSQL database. Given the extensive database activity requirements of the invention, actual implementations may need enterprise strength Database components.

1300—Database Wrapper+iNoof Base API Layer—This is a wrapper layer to access the Database in a convenient manner and follows the example of widely used standard architecture for many types of systems. Ibatis, an Open Source tool is an example of this component.

1400—Session Aware Access Controlled API Layer (IxNoofAPI)—This component is one of the interfaces exposed by the underlying backend system to the User Interface, email and other channels (such as Instant Messaging). It may be aware of the user logged-in sessions and may, in addition, apply system security. Session awareness may be integrated in the API layer.

1500—Remote Procedure Call (RPC) Service—provides an interface for the Asynchronous Java and XML (AJAX) calls to the system.

1600—This block shows inoof specific processes—identified by the dotted box in FIG. 3 and FIG. 4 and shown in greater detail in FIG. 1 and FIG. 2.

1610—The interpreters and other business logic components.

1620—The parsers. These may be intermixed with the interpreters in a multilevel parse-interpret-parse chain.

1630—The message poller (for example, an Internet Message Access Protocol (IMAP) poller)

1640—The Mail Store (for example, Post Office Protocol (POP), IMAP, Simple Mail Transport Protocol (SMTP))—the message store of the system.

1700—Email Client—any email client (could be phone or pc or web etc based).

1800—Content Management System (CMS) Data Store—this may contain some of the static content, for instance, content for the site etc.

1900—Portlets—are components of the user interface that may be related to the CMS part of the system or may be custom Portlets. Portlets are pluggable user interface components that are managed and displayed in a web portal. Portlets produce fragments of markup code that are aggregated into a portal page.

2000—Asynchronous Java And XML Layer (AJAX)—the intermediate client for processing and supporting AJAX calls.

2100—Web Browser—such as Internet Explorer or FireFox etc.

I claim:

1. A method of communication of information in a computer network comprising the steps of:
(a) Receiving an electronic message;
(b) Checking the said message against preset access authorization;
(c) If said authorization fails, then directing said message to a holding area of the system;
(d) Checking said message against preset validating information;
(e) If said validating process fails, then directing said message to a holding area of the system;
(f) Processing said message according to preset criteria;
(g) Forwarding a copy of said message processed according to said criteria to recipient or recipients identified in said message.

2. A system comprising:
(a) A component that receives an electronic message from a computer network;
(b) A component that checks said message against preset access authorization;
(c) A component that checks said message against preset validating information;
(d) A component that processes said message according to preset criteria;
(e) A component that forwards a copy of said message processed according to said criteria to recipient or recipients identified in said message.
(f) One or more holding areas for messages that may not be forwardable to said recipient or recipients of said message.

3. A system of claim 2 further comprising a component that holds predefined identifying information relating to a user of the system.

4. A system of claim 3 further comprising a component that processes said identifying information relating to said user according to predefined steps.
